(19) United States
(12) Patent Application Publication
(10) Pub. No.: US 2025/0076220 A1
(43) Pub. Date: Mar. 6, 2025

(54) X-RAY IMAGING APPARATUS

(71) Applicant: Adaptix Ltd, Begbroke (GB)

(72) Inventor: Mark Evans, Witney (GB)

(21) Appl. No.: 18/951,862

(22) Filed: Nov. 19, 2024

Related U.S. Application Data
(63) Continuation of application No. PCT/GB2023/051254, filed on May 12, 2023.

(30) Foreign Application Priority Data
May 19, 2022 (GB) 2207350.6

(51) Int. Cl. G01N 23/044; G01N 23/083; G01N 23/18

(52) U.S. Cl. CPC G01N 23/044; G01N 23/083; G01N 23/18; G01N 2223/3303

(57) ABSTRACT

An X-ray imaging apparatus (110) for imaging helicopter rotor blades (20) attached to helicopters, the apparatus comprising an upper arm (140), a lower arm (150), and a connecting member (145) for maintaining the upper and lower arms stationary relative to one another, wherein one of the upper and lower arms includes at least one X-ray source (141), and wherein the other of the upper and lower arms includes a digital X-ray detector, the apparatus including movement means (160, 170) for moving the apparatus relative to the blade, in use, and a controller configured to control the X-ray source and X-ray detector, such that in use multiple 3-dimensional X-ray images of the blade are creatable.

### RELATED APPLICATIONS

This application claims the benefit under 35 U.S.C. § 120, and is a continuation, of co-pending International Application PCT/GB2023/051254, filed May 12, 2023 and designating the US, which claims priority to GB Application 2207350.6, filed May 19, 2022, such GB Applications also being claimed priority to under 35 U.S.C. § 119. These GB and International applications are incorporated by reference herein in their entireties.

### FIELD

The present invention relates generally to an X-ray imaging apparatus and a method of producing 3-dimensional X-ray images and finds particular, although not exclusive, utility in producing X-ray images of a rotor blade attached to a helicopter.

### BACKGROUND

Helicopter rotor blades are highly sophisticated products, consisting of a matrix of various materials and composites. Each rotor blade may be manufactured as a composite, with foam or honeycomb materials forming the core of the blade. The blades may be covered with one or more layers of fibre-reinforced plastics on the outside. For further reinforcement, carbon, Kevlar or glass fibres may be used in highly stressed areas, such as the trailing edge and other complex parts, such as the “rear-wall corner joints” of the composite frame, or “foam stress” of the foam within the forward part of the blade.

The continued exposure to severe load spectrums often induces damage in the rotor blade, and continuous periodic inspections are required to ensure continued availability of the helicopter and its safe operation. However, the inspection of these structures is not a trivial matter, with the complexity of design and myriad of materials used, particularly for inner structures, where geometry and different material properties and anisotropy make inspection difficult.

Although several studies have examined the ability of structural health monitoring (SHM) methods for detecting and characterising damage with continued flight cycles, traditional non-destructive testing (NDT) modalities such as ultrasonic testing, bond testing and the simple tap test remain useful and in use.

Rotor blades are routinely visually inspected to detect surface cracks and corrosion. Manual acoustic inspection is done by tapping the rotor blades with a hammer and then noting the impact sound to determine whether the substructure's bond is intact or has separated. This tests for delamination between the alloy skin and the leading-edge spar or blade root reinforcing strip. These tests are time-consuming, cannot be automated and can have a high incidence of error. Also, these tests make it very difficult to discover any damage not visible on the outside. These traditional NDT methods remain essential tools for establishing the continued safety of helicopter at operational facilities, and also at maintenance, repair and overhaul facilities where they are used to pinpoint damage sites that guide repair operations, so as to minimize the removal of undamaged components and materials, and also ensure repairs are effective.

Device are known which use Computed Radiography whereby an image is captured on a flexible, reusable imaging plate coated with a phosphor material. The imaging plate is then scanned by a laser scanner producing a digital image. Other known devices are those which use fluoroscopy, or Real-Time Radiography (RTR), whereby radiation is emitted into one side of a material and sensors on the other side convert the rays into light, producing a digital image that reveals corrosion, and internal/external defects in real time. The known methods only produce 2D images.

Large-scale units are known which produce 3D X-ray images. However, for certain components which are attached, for example, to a helicopter, they need to be removed before being scanned. Also, due to the power of the X-rays required to acquire good image quality, the device must be shielded in a bunker, which means objects are limited to around 2 m×2 m in size. A helicopter blade would not fit into such a known device.

### SUMMARY

There is, therefore, a need for a device for producing 3D X-ray images of relatively large objects, such as helicopter rotor blades, and without the need to remove them from their attachment point to other objects, such as helicopters.

In a first aspect, the present invention provides an X-ray imaging apparatus for imaging helicopter rotor blades attached to helicopters, the apparatus comprising an upper arm, a lower arm, and a connecting member for maintaining the upper and lower arms stationary relative to one another, wherein one of the upper and lower arms includes at least one X-ray source, and wherein the other of the upper and lower arms includes a digital X-ray detector, the apparatus including movement means for moving the apparatus relative to the blade, in use, and a controller configured to control the X-ray source and X-ray detector, such that in use multiple 3-dimensional X-ray images of the blade are creatable.

In this manner, the blade may be exposed to X-rays without need of removing it from the helicopter. In use, the apparatus may be lifted into position from the ground by means of typical lifting devices such as scissor lifts, cherry pickers, cranes and the like.

The movement means for moving the apparatus relative to the blade, in use, may include blade engagement means for driving the apparatus across the first and/or second outer surfaces of the blade. For instance, wheels, tracks and other ground engagement means may be used. In this way, the apparatus may be considered to be self-propelled and/or portable.

The X-ray imaging apparatus may be arranged to be supported entirely by the blade, in use. This may be effected by the relatively light weight nature of the apparatus. This relative light weight nature may be achieved by use of flat panel emitters using relatively low power rated equipment to turn on and off the X-ray emitters in the array.

The X-ray imaging apparatus may include ground supporting means, and the movement means for moving the apparatus relative to the blade, in use, may include ground engagement means for moving the apparatus along the ground surface on which the helicopter, in use, is locatable.

For example, a scaffold may be provided, supported on a moveable trolley, with the apparatus located above ground level, supported by the scaffold so as to access the blade. The trolley may include the ground engagement means so as to be movable along the ground surface, thus moving the apparatus relative to the blade.

The ground supporting means may comprise a scissor lift for raising and lowering the X-ray source and X-ray detector relative to the ground, in use.

The X-ray imaging apparatus may further comprise a tape, attachable to the blade, wherein the tape includes fiduciary markers for providing an indication of the location of the apparatus relative to the blade, in use, by providing a marker on the creatable X-ray images. The tape may provide a mark on the X-ray images so that the location of the image relative to the blade may be ascertained.

The X-ray imaging apparatus may further comprise a processor for receiving data from the X-ray detector and for creating images of the blade.

The controller may be configured to control the movement means. In this way, the controller may move the apparatus to various positions such that the entire blade is imaged.

The X-ray source may comprise an array of X-ray emitters. The X-ray source may comprise at least one flat panel source. The X-ray imaging apparatus may be configured to produce 2D and/or 3D X-ray images.

The X-ray imaging apparatus may include X-ray source movement means for moving the at least one X-ray source relative to the upper or lower arm. Likewise, the X-ray imaging apparatus may include X-ray detector movement means for moving the X-ray detector relative to the upper or lower arm.

In this way, if the at least one X-ray source is only able to image a relatively small portion of the blade at any one time, the arm may remain stationary relative to the blade, and the at least one X-ray source and/or detector may be moved relative to the arms to image other portions of the blade, before the apparatus is moved to a new stationary position for imaging of other areas of the blade. In this way, the at least one X-ray source and X-ray detector may be relatively small and therefore relatively light-weight and inexpensive.

In a second aspect, the invention provides a method of producing 3-dimensional X-ray images of a rotor blade attached to a helicopter, comprising the steps of providing an apparatus according to the first aspect, locating the apparatus in a first position relative to the blade, such that the X-ray source is one side of the blade, and the X-ray detector is the other side of the blade, operating the apparatus to emit X-rays from the X-ray source and detect the X-rays with the X-ray detector to thereby produce an image, moving the apparatus to a second and subsequent positions relative to the blade, and operating the apparatus to emit X-rays from the X-ray source and detect the X-rays with the X-ray detector, to thereby produce further second and subsequent images.

The method may further comprise the step of creating X-ray images of at least one portion of blade at repeated intervals and comparing the images to provide an indication of possible structural failure and/or damage of the blade.

The method may further comprise the step of moving the apparatus across the width and length of the blade in incremental steps and operating the X-ray source and X-ray detector at each step to thereby produce multiple images.

The method may further comprise the step of the processor employing image recognition methods to join together the X-ray images to produce single images of larger portions of the blade.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a perspective view of an X-ray imaging apparatus; and

FIG. 2 is an end view if an alternative X-ray imaging apparatus.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

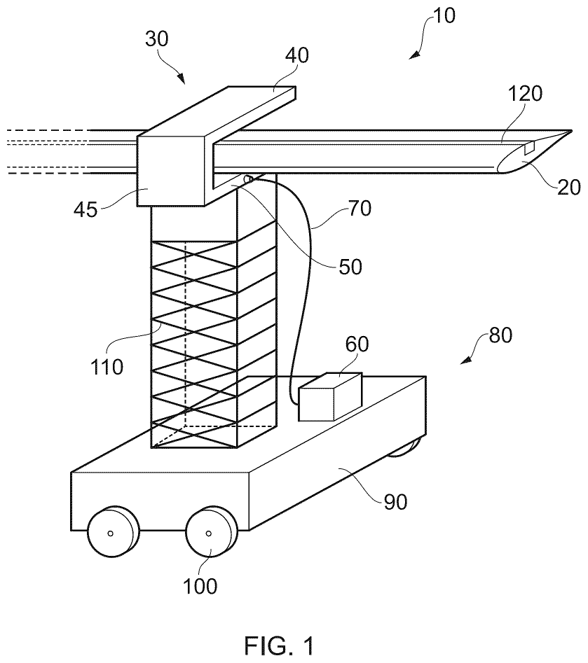

In FIG. 1, an X-ray imaging apparatus 10 is depicted comprising a C-arm 30 having an upper arm 40, a lower arm 50 and a connecting portion 45.

The C-arm 30 is arranged around a rotor blade 20 such that the upper arm 40 is above the upper surface of the rotor blade 20, and the lower arm 50 is below the rotor blade. The helicopter to which the rotor blade 20 is attached is not shown but would be to the left of the drawing.

A predetermined sized gap is typically maintained between the blade 20 and the upper arm, and between the blade and the lower arm. The connecting portion is located to one side of the rotor blade 20. The connecting portion 45 maintains the position of the upper arm 40 relative to the lower arm 50 at all times. In this way, the C-arm 40 may move relatively along the length of the rotor blade 20.

The C-arm 30 is supported off the ground by a support means no, which is approximately indicated as a scissor lift. The support means 110 may take a different form such as a hydraulic ram, or other such devices where the height of the C-arm is adjustable.

The support means no is located on a trolley 80 which includes a base 90 and four wheels 100 for movement thereof.

The support means may be arranged to lift and/or lower the C-arm 30 above the trolley 80 so as to place it around the blade 20.

A controller 60 is arranged on the trolley connected to the C-arm by cable So, although the controller may be arranged in the C-arm or remote from the apparatus 10.

The upper arm 40 includes one or more X-ray emitter, and the lower arm 50 includes a digital X-ray detector. It is contemplated that these positions can be reversed if desirable. In use, the X-ray emitter is controlled by the controller 60 to emit X-rays through the blade 20 such that they are detected by the detector in the lower arm 50.

In use, the trolley 80 is movable along the length of the blade 20 such that the entire blade 20 may be imaged in this way.

The C-arm 30 may be sized such that the entire width of the blade 20 fits under the upper arm 40 and above the lower arm 50. In this regard, the term “width” may mean the dimension lying in the plane parallel to the ground surface and perpendicular to the longitudinal length of the blade 20.

Alternatively, if the width of the blade is too great to completely fit under the upper arm, the apparatus 10 may be relocated relative to the blade 20, such that the open end of the C-arm is on the opposite side of the blade from that shown in FIG. 1.

Wheels 100 are arranged on opposite sides of the trolley such that the trolley 80 is movable along the longitudinal length of the rotor blade 20. However, it is contemplated that other wheels, or movement means may be included instead of, or as well as, the wheels 100 shown. In this way, the trolley 80 may be more easily positionable. For instance, continuous tracks may be provided. The wheels may be motorised such that, in use, the trolley 10 moves along under the longitudinal length of the blade 20. The wheels could be replaced with continuous tracks. The wheels/tracks may be steerable such that the apparatus 10 is not only moveable along the longitudinal length of the blade 20 but is also positionable width-wise of the blade.

The apparatus 110 may be controlled such that its speed of movement relative to the blade 20 matches that of its image capturing.

Also, the support means no may be rotatable, about a vertical axis, relative to the trolley deck 90 so that the open end of the C-arm 30 may be positioned, as required, relative to the blade 20. The apparatus 10 is configured such that no force is applied to the blade 20 during imaging, for instance, by the apparatus 10 touching the blade 20.

A tape 120 is shown arranged along the upper surface of the longitudinal length of the blade 20. This includes X-ray visible fiduciary markers such that when included in an X-ray image, the location of the image relative to the blade is known.

The apparatus 10 may be controlled such that its speed of movement relative to the blade 20 matches that of its image capturing. The apparatus may be configured to stop at each X-ray image acquisition site.

The apparatus 10 is arranged to move in all directions within a horizontal plane parallel to the ground surface.

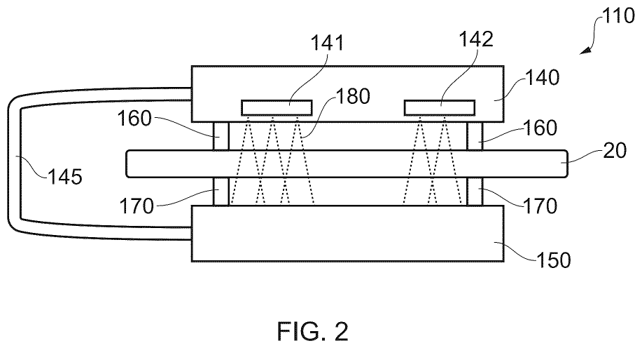

In FIG. 2, an end view of an alternative apparatus 110 is shown. The blade 20 is located horizontally between an upper arm 140 and a lower arm 150. The two arms 140, 150 are attached together by a connection member 145, arranged to the side of the blade 20. The connection member 145 maintains the position of the upper arm 140 relative to the lower arm 150 at all times. The upper arm includes wheels 160 arranged underneath which rest, in use, on the upper surface of the blade 20. Likewise, the lower arm 150 includes wheels 160 arranged above which contact, in use, the lower surface of the blade 20.

The upper arm 140 includes one or more X-ray source/emitter 141, and the lower arm 150 includes a digital X-ray detector. It is contemplated that the source/emitter could be located in the lower arm, with the detector in the upper arm, if desirable. In use, the X-ray emitter is controlled by a controller to emit X-rays 180 through the blade 20 such that they are detected by the detector in the lower arm 150.

The wheels 160, 170 act to maintain the one or more X-ray emitter at a predetermined distance away from the upper surface of the blade 20. Likewise, the wheels maintain the detector at a predetermined distance away from the lower surface of the blade 20.

The wheels 160, 170 are motorised such that, in use, the apparatus 110 moves along the longitudinal length of the blade 20. The wheels could be replaced with continuous tracks. The wheels/tracks may be steerable such that the apparatus 110 is not only moveable along the longitudinal length of the blade 20 but is also positionable width-wise of the blade so that the entire width of the blade is image-able.

The apparatus no may be controlled such that its speed of movement relative to the blade 20 matches that of its image capturing.

The apparatus 110 is arranged to move in all directions within a horizontal plane parallel to the ground surface. The apparatus may be configured to stop at each X-ray image acquisition site.

The apparatus no may include means for varying the distance of the upper and/or lower arms away from the upper and/or lower surfaces of the blade, for instance, through the use of adjustable wheel or track suspension systems, to accommodate blades which do not have uniform thicknesses, or profiles.

The X-ray source/emitter 141 is shown as only extending across a portion of the width of the upper arm 140. This X-ray source/emitter 141 may be movable relative to the upper arm, for instance, by X-ray source movement means such as an electric motor, to other positions across the width of the upper arm 140. A second position 142 is indicated to the right of the first position 141.

Alternatively, X-ray sources/emitters may be arranged across the full width of the upper arm 140.

Although not shown in FIG. 2, it will be understood that a tape could be applied to the surface of the blade in a similar manner, and for similar reasons, to the tape 20 discussed with respect to FIG. 1.

Images produced by using either apparatus 10, 110 may be ‘stitched’ together using computer processing methods to create larger images. The fiduciary markers in the tape 120 may assist in this process. In this regard, the apparatus 10, 110 may include a processor for producing images from the signals provided by the detectors.

The images may be 2D or in a 3D tomosynthesis form.

Either apparatus 10, 110 may include geolocational equipment, such as GPS, to aid positioning of the apparatus and identification of resultant images.

1. An X-ray imaging apparatus for imaging helicopter rotor blades attached to helicopters, the apparatus comprising:
an upper arm;
a lower arm; and
a connecting member for maintaining the upper and lower arms stationary relative to one another, wherein one of the upper and lower arms includes at least one X-ray source, and wherein the other of the upper and lower arms includes a digital X-ray detector, the apparatus including movement means for moving the apparatus relative to the blade, in use, and a controller configured to control the X-ray source and X-ray detector, such that in use multiple 3-dimensional X-ray images of the blade are creatable.

2. The X-ray imaging apparatus of claim 1, wherein the movement means for moving the apparatus relative to the blade, in use, include blade engagement means for driving the apparatus across the first and/or second outer surfaces of the blade.

3. The X-ray imaging apparatus according to claim 1, arranged to be supported entirely by the blade, in use.

4. The X-ray imaging apparatus of claim 1, including ground supporting means, and wherein the movement means for moving the apparatus relative to the blade, in use, include ground engagement means for moving the apparatus along the ground surface on which the helicopter, in use, is locatable.

5. The X-ray imaging apparatus of claim 4, wherein the ground supporting means comprises a scissor lift for raising and lowering the X-ray source and X-ray detector relative to the ground, in use.

6. The X-ray imaging apparatus of claim 1, further comprising a tape, attachable to the blade, wherein the tape includes fiduciary markers for providing an indication of the location of the apparatus relative to the blade, in use, by providing a marker on the creatable X-ray images.

7. The X-ray imaging apparatus of claim 1, further comprising a processor for receiving data from the X-ray detector and create images of the blade.

8. The X-ray imaging apparatus of claim 1, wherein the controller is configured to control the movement means.

9. The X-ray imaging apparatus of claim 1, wherein the X-ray source comprises an array of X-ray emitters.

10. The X-ray imaging apparatus of claim 9, wherein the X-ray source comprises at least one flat panel source.

11. The X-ray imaging apparatus of claim 1, including X-ray source movement means for moving the at least one X-ray source relative to the upper or lower arm.

12. The X-ray imaging apparatus of claim 1, including X-ray detector movement means for moving the X-ray detector relative to the upper or lower arm.

13. A method of producing 3-dimensional X-ray images of a rotor blade attached to a helicopter, comprising the steps of providing an apparatus according to claim 1, locating the apparatus in a first position relative to the blade, such that the X-ray source is one side of the blade, and the X-ray detector is the other side of the blade, operating the apparatus to emit X-rays from the X-ray source and detect the X-rays with the X-ray detector to thereby produce an image, moving the apparatus to a second and subsequent positions relative to the blade, and operating the apparatus to emit X-rays from the X-ray source and detect the X-rays with the X-ray detector, to thereby produce further second and subsequent images.

14. The method of claim 13, further comprising the step of creating X-ray images of at least one portion of blade at repeated intervals and comparing the images to provide an indication of possible structural failure and/or damage of the blade.

15. The method of claim 13, further comprising the step of moving the apparatus across the width and length of the blade in incremental steps and operating the X-ray source and X-ray detector at each step to thereby produce multiple images.

16. The method of claim 13, further comprising the step of the processor employing image recognition methods and joining together the X-ray images to produce single images of larger portions of the blade.
